(19) United States
(12) Patent Application Publication
(10) Pub. No.: US 2023/0074977 A1
(43) Pub. Date: Mar. 9, 2023

(54) MULTI-BAND PUMPING OF DOPED FIBER SOURCES

(71) Applicant: nLIGHT, Inc., Camas, WA (US)

(72) Inventors: Tyson L. Lowder, Vancouver, WA (US); Dahv A.V. Kliner, Portland, OR (US)

(73) Assignee: nLIGHT, Inc., Camas, WA (US)

(21) Appl. No.: 17/759,719

(22) PCT Filed: Jan. 29, 2021
(86) PCT No.: PCT/US2021/015913

§ 371 Date: Jul. 28, 2022

Related U.S. Application Data
(60) Provisional application No. 62/968,110, filed on Jan. 30, 2020.

(51) Int. Cl. H01S 3/094; H01S 3/16; H01S 3/0941; H01S 3/067; H01S 3/091

(52) U.S. Cl. CPC H01S 3/094096; H01S 3/094003; H01S 3/1618; H01S 3/094053; H01S 3/09415; H01S 3/0675; H01S 3/0912

(57) ABSTRACT

Disclosed are embodiments for multi-band pumping of a doped fiber source. The doped fiber source has a first absorption band and a second absorption band that is different from the first absorption band. In some embodiments, a first laser pump generates a first pump power in a first pump band corresponding to the first absorption band that is generated. A second laser pump generates a second pump power in a second pump band corresponding to the second absorption band. The second pump band is different from the first pump band. The first and second pump power is simultaneously applied to the doped fiber source.

### RELATED APPLICATION

This application claims priority benefit of U.S. Provisional Patent Application No. 62/968,110, filed Jan. 30, 2020, which is hereby incorporated by reference in its entirety.

### TECHNICAL FIELD

The disclosure pertains to industrial fiber source assemblies.

### BACKGROUND INFORMATION

Yb-doped fiber sources (i.e., amplifiers or lasers) have been pumped at either the 920 nm or 976 nm Yb-absorption bands. Among these two approaches, there are tradeoffs in terms of temperature dependence and overall efficiency of the system. A desirable laser system design, however, would minimize temperature dependence of the pumps while simultaneously maximizing the overall efficiency of the system. Laser efficiency may refer to the efficiency of converting optical pump power into optical signal power or may refer to the efficiency of converting electrical power to optical signal power. In either case, higher laser efficiency generally leads to better laser performance and lower manufacturing cost to the supplier and lower operating costs to the end user.

In general, unlocked pumps are pumps where the output wavelength has a strong dependence on the temperature at which they are operating. Locked pumps are pumps that usually have a much smaller output wavelength dependence on the temperature at which they operate. Volume Bragg grating (VBG) is an optical element used external to a laser diode waveguide cavity to provide wavelength-dependent optical feedback to promote locking of the laser diode.

Minimizing the temperature dependence of the pumps can be advantageous in lasers intended to operate over a wide temperature range or in other circumstances such as a cold-start turn-on. In the latter situation, the pump lasers are often much colder at turn-on compared to their steady-state condition, which might not occur for several tens of seconds to minutes later, depending on the particular thermal management solution for that laser.

### SUMMARY OF THE DISCLOSURE

Disclosed are some embodiments for multi-band pumping of a doped fiber source, in which the doped fiber source has a first absorption band and a second absorption band that is different from the first absorption band. Some embodiments include generating from a first laser pump a first pump power in a first pump band corresponding to the first absorption band; generating from a second laser pump a second pump power in a second pump band corresponding to the second absorption band, the second pump band being different from the first pump band; and simultaneously applying to the doped fiber source the first and second pump power.

The first and second pump power may be different or equal. In some embodiments, the second pump power is greater than the first pump power.

In some embodiments, the doped fiber source is a Yb-doped fiber source, which may either be a doped fiber laser or a doped fiber amplifier.

In some embodiments, the first absorption band may have a peak wavelength in a range from about 910 nm to about 930 nm, or the peak wavelength is in a range from about 930 nm to about 960 nm. And the second absorption band may have a peak wavelength in a range from about 970 nm to about 980 nm.

Some disclosed embodiments both reduce temperature dependence of pumps on the laser system performance while simultaneously increasing the overall efficiency of the laser system. It is believed that such embodiments would be both readily manufacturable and cost effective.

Additional aspects and advantages will be apparent from the following detailed description of embodiments, which proceeds with reference to the accompanying drawings.

### BRIEF DESCRIPTION OF THE DRAWINGS

The accompanying drawings, wherein like reference numerals represent like elements, are incorporated in and constitute a part of this specification and, together with the description, explain the advantages and principles of the presently disclosed technology. In the drawings,

FIG. 1 is a graph illustrating normalized Yb-absorption cross section, in which a first box around 920 nm indicates that this pump band is wide yet weak, and a second box around 976 nm indicates that this pump band is narrow but strong;

FIG. 2 is a graph illustrating pump ensemble spectra overlaid against the Yb-absorption spectrum, in which the long-dashed spectra show where the spectra might be relative to the absorption bands when the pumps are cold, and in which the short-dashed spectra show that same relationship once the pumps have reached thermal equilibrium, i.e., when the temperature of the pump (including laser diode chips) has reached a steady state value such that its spectrum substantially stops moving;

FIG. 3 is a graph illustrating laser output power over time for an all 920 nm pumped Yb-doped fiber source and an all 976 nm unlocked pumped Yb-doped fiber source;

FIG. 4 is a fiber laser system component diagram configured for dual-band pumping of a Yb-doped fiber, according to one embodiment;

FIG. 5 is a graph illustrating an even mixed dual-band pumping spectrum relative to the Yb-absorption band, in which even pumping means that the two pump bands contain roughly equal power;

FIG. 6 is a graph illustrating expected laser output power over time for a laser with a pump ensemble for which equal power is applied in both the 920 nm and 976 nm bands;

FIG. 7 is a graph illustrating an uneven mixed dual-band pumping spectrum relative to the Yb-absorption band, in which uneven pumping means that the two pump bands contain different amounts of power;

FIG. 8 is a graph illustrating expected laser output power over time for a laser where the pump power distribution between the 920 nm and 976 nm bands has been optimized to compensate for the slow time constants of the thermal management solution;

FIG. 9 is a flowchart showing a process for multi-band pumping, according to one embodiment; and

FIG. 10 is a block diagram showing components configured to control a multi-band pumping system, according to one embodiment.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus are referred to as “lowest,” “best,” “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description, but do not imply any particular spatial orientation. For the sake of simplicity and readability, in the drawings single elements are labeled. Where there is a plurality of identical elements, representative example elements will be labeled rather than labeling each of the plurality of elements.

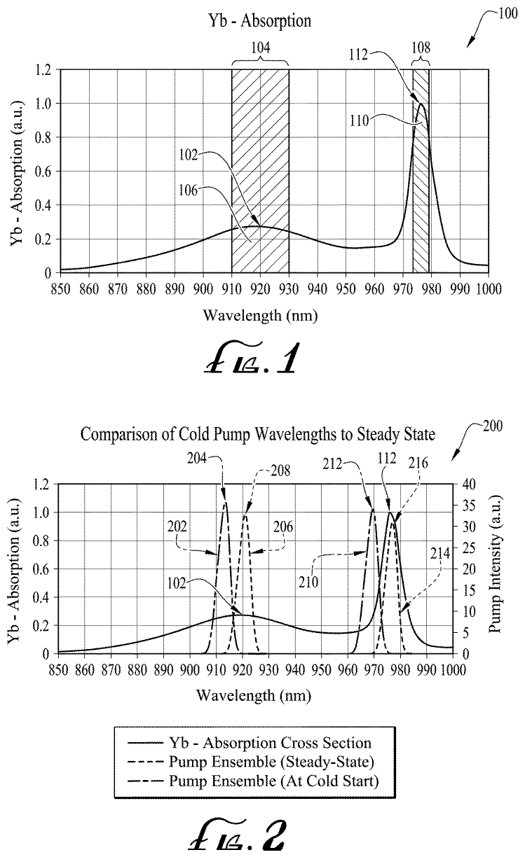

FIG. 1 is a Yb-absorption spectra graph 100 that, on the one hand, shows a first Yb-absorption peak 102 is broad around a 920 nm pump band 104. This means that lasers pumped in this region will have little dependence on temperature fluctuations of the pumps. A disadvantage of pumping in 920 nm pump band 104, however, is that a first Yb-absorption cross section region 106 is somewhat weak around 920 nm pump band 104, which can be detrimental to overall laser efficiency. On the other hand, Yb-absorption spectra graph 100 shows that pumping around a 976 nm pump band 108 can lead to improved overall laser efficiency because of a second Yb-absorption cross section region 110 that is greater than first Yb-absorption cross section region 106. A disadvantage of pumping in 976 nm pump band 108, however, is the narrow width of the absorption peak, which can lead to greater temperature dependence. Specifically, as the temperatures of pumps change, the pumping wavelength slews away from a second Yb-absorption peak 112, leading to lower efficiency and potentially large amounts of transmitted pump light, which may be adequately handled elsewhere in the system.

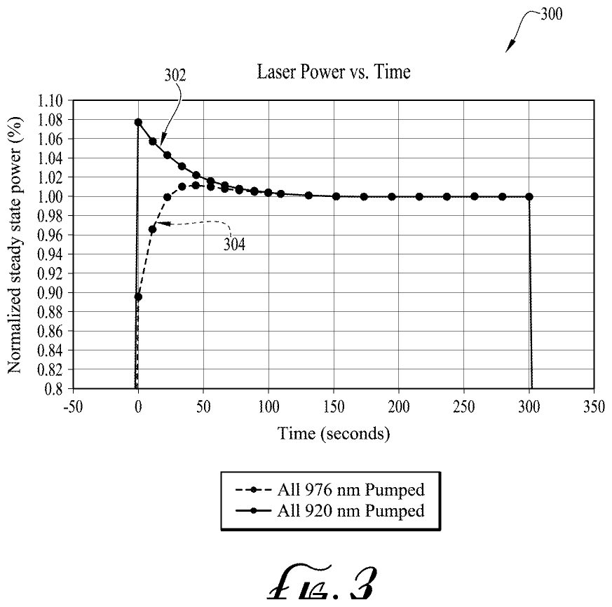

FIG. 2 is a graph 200 showing a difference between pumping wavelengths at a cold start (in broken lines) and steady-state, both of which are shown relative to first Yb-absorption peak 102 and second Yb-absorption peak 112. For example, a cold 920 nm pump wavelength 202 has an initial peak wavelength 204 at about 913 nm. As the 920 nm pump warms and reaches its thermal equilibrium, it is shown as a steady-state 920 nm pump wavelength 206 having a steady-state peak wavelength 208 at the specified 920 nm. Likewise, a cold 976 nm pump wavelength 210 has an initial peak wavelength 212 at about 969 nm. As the 976 nm pump warms and reaches its thermal equilibrium, it is shown as a steady-state 976 nm pump wavelength 214 having a steady-state peak wavelength 216 at the specified 976 nm.

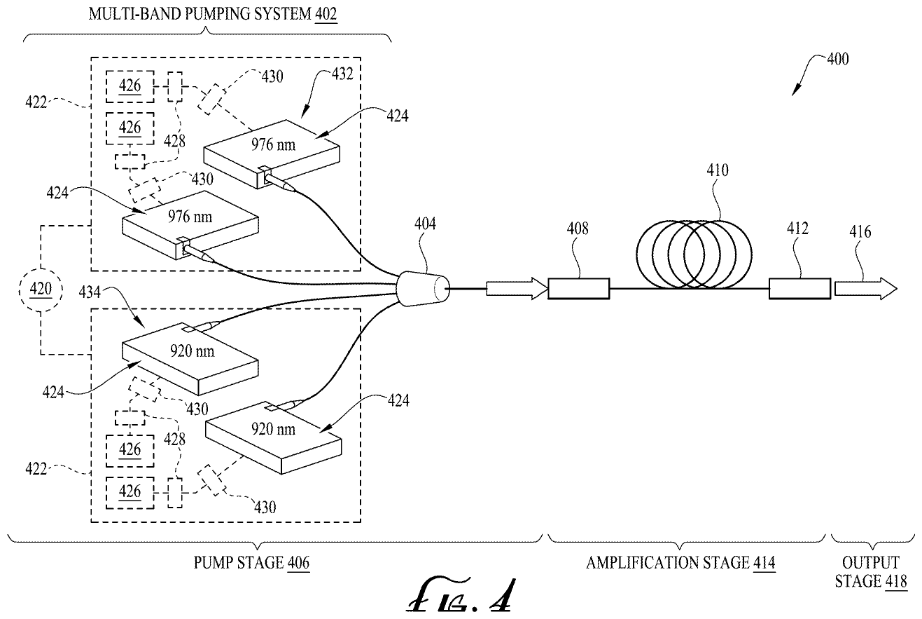

FIG. 3 shows a graph 300 of time in which pumps (represented in graph 200 of FIG. 2) reach steady-state optical power production at their thermal equilibrium. A first plot 302 shows laser output power overshooting when all 920 nm pumping is employed. A second plot 304 shows laser output power undershooting when all 976 nm, unlocked, pumping is used. Long time constants to reach thermal equilibrium of the system can lead to undesirable dynamics (severely undershooting or overshooting) in the output power of the laser compared to steady-state operation.

Specifically, in first plot 302, the laser output power that is all 920 nm pumped overshoots mainly due to the increased pump power that is available as the pump is initially cold at turn-on (due to a negative dPower/dTemperature constant). Conversely, in second plot 304, the laser output power that is all 976 nm pumped undershoots mainly due to the slewing of the pump from a cold wavelength to a warmer wavelength (positive dLambda/dTemperature constant). The wavelength difference of the 976 nm pumps and the Yb-absorption band has a greater effect on the output power than the extra power that is available from those pumps at turn-on.

FIG. 4 shows a fiber laser system 400 including a multi-band pumping system 402 (shown in broken lines) and a pump laser combiner 404 forming a pump stage 406; a high reflectivity fiber Bragg grating 408, a Yb-doped fiber source 410 as an amplification medium, and a low reflectivity fiber Bragg grating 412 forming an amplification stage 414; and a fiber output 416 as an output stage 418. Each of these stages 406, 414, and 418 is described in more detail as follows.

With reference to pump stage 406, multi-band pumping system 402 receives input power from a high-power electrical receptacle 420. The input power is applied to multiple laser pumps 422, each of which includes one or more diode lasers 424. In some embodiments, diode laser 424 are element® diode lasers available from the applicant, nLIGHT, Inc., of Vancouver, Wash.

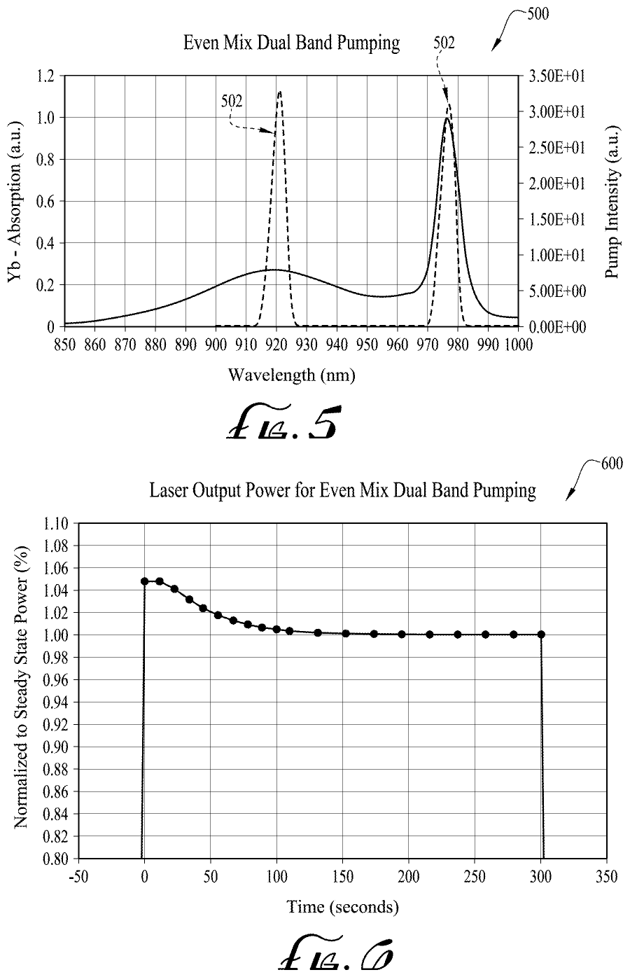

Each one of diode laser 424 is powered by a corresponding different one of multiple AC/DC pump power supplies 426. The amount output power of each of multiple AC/DC pump power supplies 426 is applied to a corresponding one of diode lasers 424, via a diode laser driver 428, which is controlled based on a laser pump controller 430 (see e.g., FIG. 10) configured to control (dynamically or statically) desired mixes of pump power described later with reference to FIG. 5 and FIG. 7.

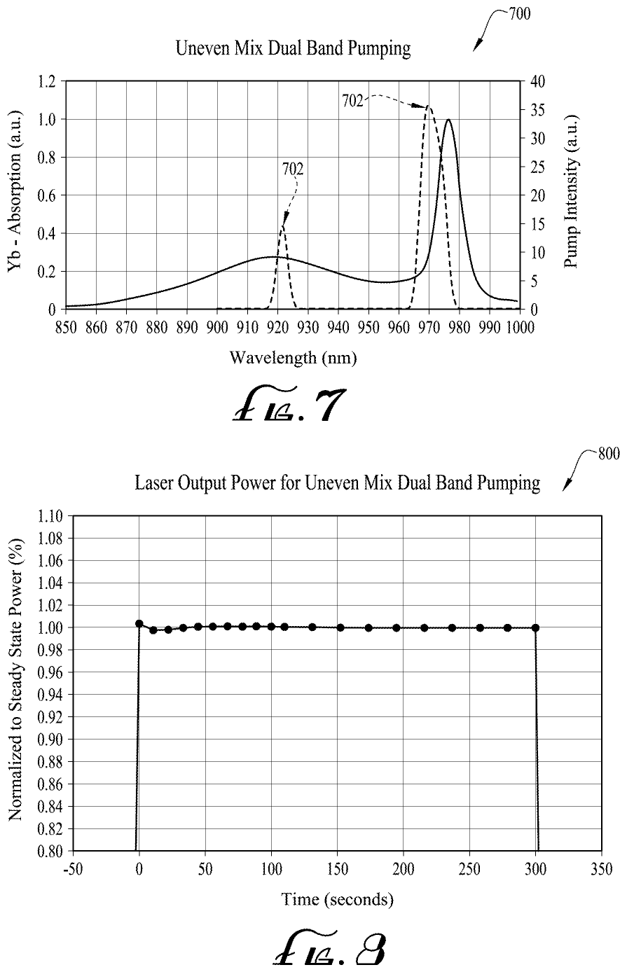

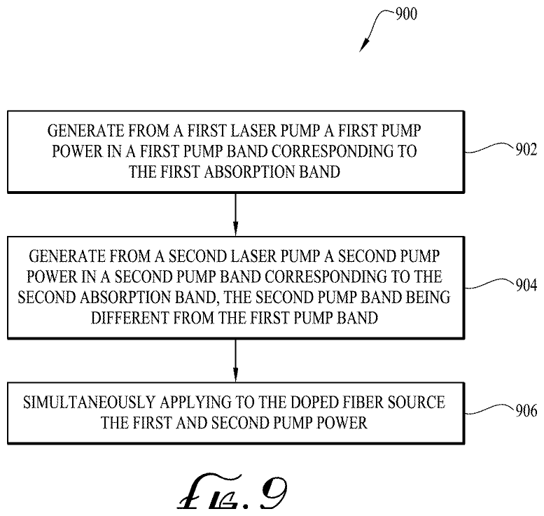

In the present example, multiple laser pumps 422 include a first type of diode laser 432 (e.g., a pair of 976 nm diode lasers) and a second type of diode laser 434 (e.g., a pair of 920 nm diode lasers). Thus, multi-band pumping system 402 is configured to generate simultaneous dual-band pumping, e.g., in the 920 nm and 976 nm bands. As shown and described later with reference to FIG. 6 and FIG. 8, fiber laser system 400 employs both of these pumping bands to compensate for the overshoot and the undershoot (see, e.g., FIG. 3) while simultaneously maintaining relatively high laser efficiency. This configuration takes advantage of, and limits the effects of, any single pump band, which thereby reduces temperature dependent operation and improves efficiency in laser operation.

It should be appreciated that the particular topology, control, and functionality of each one of multiple laser pumps 422—and, more generally, the topology, control, and functionality of multi-band pumping system 402—may vary, according to specific applications. For example, an AC/DC pump power supply may be configured to power multiple diode lasers that are electrically coupled together serially or in parallel. In another example, multiple diode lasers may be controlled individually or collectively from, respectively, an individual or common laser pump controller. Furthermore, each laser pump controller or diode laser driver may be configured for open- or closed-loop control based on feedback in the form of optical power sensors (e.g., photodiodes), electrical current sensors, temperature sensors, or other types of feedback that varies as a function of time. And the various components, electrical circuitry, and associated functionality of pump stage 406 may be integrated together in one or multiple discrete devices.

With reference to amplification stage 414, it should be appreciated that other types of laser architectures are also suitable for use with multi-band pumping system 402. For example, Yb-doped fiber source 410 may form an amplifier or a laser having an optical cavity. In another example, a first absorption band of Yb-doped fiber source 410 includes a peak wavelength in a range from about 910 nm to about 930 nm, or in another range from about 930 nm to about 960 nm (e.g., a shifted Yb-doped fiber band). A second absorption band of Yb-doped fiber source 410 includes a peak wavelength in the range from about 970 nm to about 980 nm. Also, high reflectivity fiber Bragg grating 408 and low reflectivity fiber Bragg grating 412 may be substituted with free space optics. Other variants are also possible.

Finally, with reference to output stage 418, it should be appreciated that in some embodiments, fiber output 416 may instead be an output beam, another amplification stage, a splice to a delivery fiber, or some other form of output including combinations of the aforementioned items.

FIG. 5 is a graph 500 showing a so-called even mix pumping scheme (with pump intensity wavelengths 502 shown in broken lines) relative to a Yb-absorption cross section 504 (shown as a solid line). Even (also referred to as equal) pumping attempts to reduce and minimizes voltage differences between first type of diode laser 432 (FIG. 4) and second type of diode laser 434 (FIG. 4) so as to reduce losses. This is so because some laser architectures perform better by using an equal mix of both 920 nm and 976 nm pumping.

FIG. 6 shows expected power vs. turn-on time graph 600 for the embodiment shown in FIG. 5. As can be seen in FIG. 6 compared to FIG. 3, the laser dynamics at turn-on are somewhere between both of the single pump band situations and are mainly dependent on the exact wavelengths chosen and the thermal time constants of the thermal management solution.

FIG. 7 is a graph 700 showing a so-called uneven mix pumping scheme (with pump intensity wavelengths 702 shown in broken lines) relative to a Yb-absorption cross section 704 (shown as a solid line). In this embodiment, the mix of the multiple pump-band powers need not be equal. For example, cold pump power at 970 nm is greater than that at 921 nm.

In certain applications, it is advantageous to pursue a laser architecture allowing for uneven pump mixes in order to compensate for the thermal time constants of the thermal management solution. For example, some applications perform better with a short power decay or power rise to the steady-state power. These decays/rises, however, are due to the thermalization of the pumps causing their output power and output wavelength to stabilize. In this situation, one could characterize the thermal response of the laser system and then mix the pumps as desired to even out the output power response. FIG. 7, for example, shows the mix selected to compensate for a thermal management system with a time constant of about 35 seconds, in which the value of the time constant is obtained through one of both of empirical test results and design parameters.

FIG. 8 is a graph 800 showing resulting output power over time after a turn-on event for the uneven mix pumping scheme described with reference to FIG. 7. The laser output curve shows how the embodiment almost completely overcomes any undesirable rise or decay in output power.

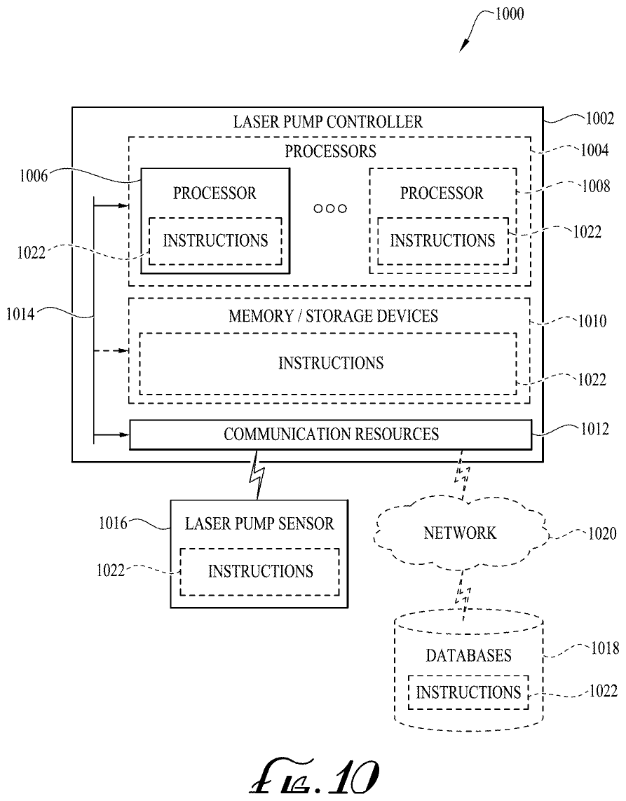

FIG. 9 shows a process 900 for multi-band pumping of a doped fiber source, in which the doped fiber source has a first absorption band and a second absorption band that is different from the first absorption band. Process 900 entails generating 902 from a first laser pump a first pump power in a first pump band corresponding to the first absorption band. Process 900 also entails generating 904 from a second laser pump a second pump power in a second pump band corresponding to the second absorption band, in which the second pump band is different from the first pump band. Process 900 further entails simultaneously applying 906 to the doped fiber source the first and second pump power.

In some embodiments, a software-control layer is implemented to facilitate individual current control to the different pumps so as to generate a mix of power applied to a doped fiber source. With the additional software layer, it is possible to control the current to the pumps as a function of time and optionally dynamically provide even further compensation to the laser output power over time response. For example, FIG. 10 is a block diagram illustrating components 1000 configured to implement a software-based pump-power control layer. Accordingly, components 1000 are configured to read instructions from a machine-readable or computer-readable medium (e.g., a non-transitory machine-readable storage medium) and perform any one or more of the methods discussed herein. According to one embodiment of components 1000, optional items are shown in broken lines.

Specifically, FIG. 10 shows a diagrammatic representation of laser pump controller 1002 including processors 1004 (or processor cores), memory/storage devices 1010, and communication resources 1012, each of which may be communicatively coupled via a bus 1014. Although bus 1014 is shown in solid lines, in other embodiments a processor includes I/O (e.g., ADC inputs) to directly monitor sensor inputs.

Processors 1004 (e.g., a central processing unit (CPU), a reduced instruction set computing (RISC) processor, a complex instruction set computing (CISC) processor, a field-programmable gate array (FPGA), a digital signal processor (DSP), an application specific integrated circuit (ASIC), another processor, or any suitable combination thereof) may include, for example, a processor 1006 and a processor 1008.

Memory/storage devices 1010 may include main memory, disk storage, or any suitable combination thereof. Memory/storage devices 1010 may include, but are not limited to, any type of volatile or non-volatile memory such as dynamic random access memory (DRAM), static random access memory (SRAM), erasable programmable read-only memory (EPROM), electrically erasable programmable read-only memory (EEPROM), flash memory, solid-state storage, etc.

Communication resources 1012 may include interconnection or network interface components or other suitable devices to communicate with laser pump sensors 1016 or databases 1018 via a network 1020. For example, communication resources 1012 may include wired communication components (e.g., for coupling via a Universal Serial Bus (USB)), cellular communication components, NFC components, Bluetooth® components (e.g., Bluetooth® Low Energy), Wi-Fi® components, and other communication components.

In some embodiments, laser pump sensors 1016 include electrical circuitry configured to monitor and control one or more of multiple AC/DC pump power supplies 426 (FIG. 4), diode laser driver 428 (FIG. 4), and diode laser 424. For example, laser pump sensor 1016 includes a current or power sensor to monitor input power to diode laser 424. In another embodiment, laser pump sensor 1016 includes an optical power sensor to measure optical power from diode laser 424. In other embodiments, laser pump sensor 1016 includes a temperature sensor or other types of sensor. Moreover, in some embodiments, one or both laser pump sensor 1016 and laser pump controller 1002 are integrated in some or all of multiple AC/DC pump power supplies 426, diode laser driver 428, and laser pump controller 430, and may be controlled or communicated with through communication resources 1012.

Instructions 1022 may comprise software, a program, an application, an applet, an app, lookup table, executable code, or other power configuration parameters capable of being processed (e.g., read, executed, etc.) for causing at least any of processors 1004 to perform any one or more of the methods discussed herein. For example, a lookup table may include desired optical power or electrical input power parameters for dynamically controlling diode lasers 424 as they reach steady state (e.g., table values temporally ramp power up for one type of pump while temporally ramping power down for a different type of pump). In another embodiment, power configuration parameters are static and pre-determined to improve efficiency during multi-band pumping. Instructions 1022 may reside, completely or partially, within at least one of the processors 1004 (e.g., within cache memory), memory/storage devices 1010, or any suitable combination thereof. Furthermore, any portion of instructions 1022 may be transferred to laser pump controller 1002 from any combination of laser pump sensor 1016 or databases 1018. Accordingly, memory of processors 1004, memory/storage devices 1010, laser pump sensor 1016, and databases 1018 are examples of computer-readable and machine-readable media.

In other embodiments, mixing of two or more pump bands could be achieved by a laser pump controller implemented exclusively or primarily in hardware (e.g., physically choosing the number of 920 nm or 976 nm pumps).

Having described and illustrated the general and specific principles of examples of the above-described multi-band pumping embodiments, it should be apparent that the examples may be modified in arrangement and detail without departing from such principles. In other words, the above-described embodiments of simultaneous dual-band pumping of Yb-doped fiber source are intended to be illustrative and not limiting. For example, the techniques are also applicable for fiber lasers doped with other substances, e.g., other rare earth dopants providing multiple absorption bands, such as neodymium (Nd³⁺), erbium (Er³⁺), thulium (Tm³⁺), co-doped systems such as Er—Yb, or other substances. Likewise, the above-described embodiments need not be limited to pumping in the 920 nm or 976 nm wavelengths for Yb-doped fiber sources. Moreover, the techniques may be used in dual- or higher-multi-band pumping of doped fiber sources. Claimed subject matter is not limited in these regards.

Skilled persons will appreciate that many changes may be made to the details of the above-described embodiments without departing from the underlying principles of the disclosure. The scope of the present invention should, therefore, be determined only by the following claims.

1. A method of multi-band pumping of a doped fiber source, the doped fiber source having a first absorption band and a second absorption band that is different from the first absorption band, the method comprising:
generating from a first laser pump a first pump power in a first pump band corresponding to the first absorption band;
generating from a second laser pump a second pump power in a second pump band corresponding to the second absorption band, the second pump band being different from the first pump band; and
simultaneously applying to the doped fiber source the first and second pump power.

2. The method of claim 1, in which the first and second pump power are equal.

3. The method of claim 1, in which the second pump power is greater than the first pump power.

4. The method of claim 1, in which the doped fiber source is a Yb-doped fiber source.

5. The method of claim 1, in which the first absorption band has a peak wavelength in a range from about 910 nm to about 930 nm.

6. The method of claim 1, in which the first absorption band has a peak wavelength in a range from about 930 nm to about 960 nm.

7. The method of claim 1, in which the second absorption band has a peak wavelength in a range from about 970 nm to about 980 nm.

8. The method of claim 1, in which the doped fiber source is a doped fiber laser.

9. The method of claim 1, in which the doped fiber source is a doped fiber amplifier.

10. The method of claim 1, in which the first and second laser pumps are diode lasers.

11-20. (canceled)

21. A multi-band pump stage for pumping a doped fiber source, the doped fiber source having a first absorption band and a second absorption band that is different from the first absorption band, the multi-band pump stage comprising:
a first laser pump configured to produce a first pump power in a first pump band corresponding to the first absorption band;
a second laser pump configured to produce a second pump power in a second pump band corresponding to the second absorption band, the second pump band being different from the first pump band; and
a pump laser combiner configured to combine the first and second pump power and simultaneously apply it to the doped fiber source.

22. The multi-band pump stage of claim 21, in which the first and second pump power are equal.

23. The multi-band pump stage of claim 21, in which the second pump power is greater than the first pump power.

24. The multi-band pump stage of claim 21, in which the doped fiber source is a Yb-doped fiber source.

25. The multi-band pump stage of claim 21, in which the first absorption band has a peak wavelength in a range from about 910 nm to about 930 nm.

26. The multi-band pump stage of claim 21, in which the first absorption band has a peak wavelength in a range from about 930 nm to about 960 nm.

27. The multi-band pump stage of claim 21, in which the second absorption band has a peak wavelength in a range from about 970 nm to about 980 nm.

28. The multi-band pump stage of claim 21, in which the doped fiber source is a doped fiber laser.

29. The multi-band pump stage of claim 21, in which the doped fiber source is a doped fiber amplifier.

30. The multi-band pump stage of claim 21, further comprising a laser pump controller configured to control one or both the first and second laser pumps.

31. The multi-band pump stage of claim 21, further comprising an AC/DC pump power supply electrically coupled to a high-power electrical receptacle.

32. The multi-band pump stage of claim 21, further comprising a diode laser driver to drive one or both the first and second laser pumps.

33. The multi-band pump stage of claim 21, further comprising a laser pump sensor configured to monitor one or both of the first and second pump power.
